(19) United States
(12) Patent Application Publication
(10) Pub. No.: US 2021/0086184 A1
(43) Pub. Date: Mar. 25, 2021

(54) CONTAINER AND METHOD FOR ACTIVATING REAGENTS IN SUCH A CONTAINER

(71) Applicant: Endress+Hauser Conducta GmbH+Co. KG, Gerlingen (DE)

(72) Inventors: Anja Gerlinger, Stuttgart (DE); Ulrich Kathe, Ludwigsburg (DE); Daniel Schweitzer, Remshalden (DE)

(21) Appl. No.: 17/031,415

(22) Filed: Sep. 24, 2020

(30) Foreign Application Priority Data
Sep. 25, 2019 (DE) 10 2019 125 836.7

(51) Int. Cl. B01L 3/00

(52) U.S. Cl. CPC B01L 3/527; B01L 3/523; B01L 3/565; B01L 2400/086; B01L 2300/044; B01L 2400/043; B01L 2300/0672; B01L 2300/0618; B01L 2300/042; B01L 2300/123

(57) ABSTRACT

The invention discloses a container for reagents for an analyzer in process automation technology, comprising an, in particular bottle-shaped, container wall which is designed to form a first compartment for a first reagent; an insert which is arranged at least in some sections in the first compartment, and which forms a second compartment separated from the first compartment for a second reagent, wherein the insert comprises a closure; and a punch which is movable at least between a first position and a second position, wherein the punch, in moving from the first position to the second position, opens, in particular cuts through, penetrates, pierces or presses out, the closure and clears a path from the second compartment into the first compartment, whereby second reagent enters the first reagent. In addition, the invention also discloses a corresponding method.

### CROSS-REFERENCE TO RELATED APPLICATION

The present application is related to and claims the priority benefit of German Patent Application No. 10 2019 125 836.7, filed on Sep. 25, 2019, the entire contents of which are incorporated herein by reference.

### TECHNICAL FIELD

The invention relates to a container for reagents for an analyzer in process automation technology and to a method for activating reagents with such a container.

### BACKGROUND

Analyzers for photometric analysis, for example in the monitoring of limit values in waters, wastewater or process waters, require in many cases operating fluids such as reagents, standard solutions or cleaning solutions for their operation. Hereinafter, these are referred to merely as “reagents.” These are often distributed by the seller of the analyzers. Usual container sizes are in the range between a few ml and 50 l.

To ensure continuous analysis operation and due to cost considerations, the user is required to adequately stock operating fluids. This is contrary to the fact that some of these fluids have only a short shelf life and thus do not survive the intended storage period without damage. For example, many salts which are inherently long-lasting can be subject to undesirable changes from light, temperature, microbial influences or air in the dissolved state required for the analysis.

To date, this problem has been addressed by delivering reagents to the user for stocking, which then have to be activated by the user himself according to manufacturer specifications before use in the analyzer. Such activation processes can be the dissolution of salts, the preparation of dilutions or the mixing of solutions.

The components for the solutions are delivered in separate vessels and must be activated prior to being inserted into the analyzers. For this purpose, laboratory equipment such as beakers, measuring cylinders, scales, funnels, spatulas, etc. as well as means for worker protection such as safety goggles, protective gloves, gowns, pure water for dilution, etc. are required. In addition, minimum requirements are placed on the personnel: Clean work, avoiding formulation errors from lack of attention or knowledge, responsibility for workers' own health and the health of others, for the environment, compliance with TLV values and other statutory provisions. It is true here that the reagents can be prepared in large amounts and in any desired mixing ratios. However, due to the complex and sometimes complicated requirements, aversions to activating reagents on site or in temporary laboratories exist. There is a great risk of formulation errors taking place and thus impairing the later analyses or even making them unusable. Thus, a reasonably equipped laboratory and professional personnel is required. In addition, at least two bottles with the corresponding space are required for one formulation. In doing so, there is a risk of getting things confused.

There are pharmaceutical and cosmetic preparations which are activated immediately before administration by the patient or before application to the skin or hair of the customer. For this purpose, bottles are filled by volume with the main component (for instance with water or solvent). A second component, usually the less shelf-stable active component, is accommodated in a bottle closure cover with a chamber separated from the main components. DE 10 2008 019222 discloses this. In this case, the activation takes place by means of a special opening mechanic, as a result of which the separation of the chamber is opened, such that the two components are combined and mixed inside the bottle. This procedure is relatively simple to carry out and only one container is required. Professional personnel is not absolutely necessary, since the various components can be combined without contact with the user. However, the amount of the component to be accommodated in the closure cover is very limited, meaning that the required mixing ratios between the two components cannot be prepared in every case. Any prescribed statutory traceability is not possible.

### SUMMARY

The object of the invention is to simplify the handling of reagents for the user.

The object is achieved by a container, comprising: an, in particular bottle-shaped, container wall, designed to form a first compartment for a first reagent; an insert which is arranged at least in some sections in the first compartment, and which forms a second compartment separated from the first compartment for a second reagent, wherein the insert comprises a closure; and a punch which is movable at least between a first position and a second position, wherein the punch, in moving from the first position to the second position, opens, in particular cuts through, penetrates, pierces or presses out, the closure and clears a path from the second compartment into the first compartment, whereby second reagent enters the first reagent.

By clearing the path from the second compartment into the first compartment, second reagent enters the first reagent. Thorough mixing, for instance by shaking or stirring, may be necessary.

Likewise, it is evident that a path from the first compartment into the second compartment also results.

As a result of the separation of the two reagents by means of the first and second compartments, the reagents are prefabricated but separated for the user. Opening the closure, which can be designed, for example, as a membrane (see below) results in the error-free preparation of the required reagents for the user. This ultimately leads to a higher quality of the analysis results.

The separation into two compartments which can also be adapted by their volume, see below for instance the embodiment as a bag (if necessary, an additional bag), makes it possible to prepare reagents which comprise a concentration range of close to 0 to close to 100%. In contrast, the prior art, which proposes solutions which are easy to handle, offers here only the possibility of dissolving small amounts of a first reagent in a relatively large volume of a second reagent.

One embodiment provides that the closure is designed as a membrane. One embodiment provides that the membrane consists of the same material as the insert, see below. One embodiment provides that the membrane consists of an, in particular double or triple, aluminum plastic composite film. In general, one embodiment provides that the membrane is resistant to the first and second reagents and no solvent diffuses through the membrane.

One embodiment provides that the punch is arranged in the insert and is movably mounted within the insert.

One embodiment provides that the closure is arranged at an end region of the insert. One embodiment provides that the closure is arranged on the end region which faces the first compartment.

One embodiment provides that the punch comprises a seal which is arranged on the outer diameter of the punch.

One embodiment provides that the punch is designed as a hollow body.

One embodiment provides that the punch comprises a closure plug which comprises a predetermined breaking point, wherein a reagent removal tube can be pushed through the predetermined breaking point after the breaking.

One embodiment provides that the reagent removal tube is arranged not in a form-fitting manner in the predetermined breaking point. The reagent removal tube is thus fixed, but there is also an air opening to the atmosphere for easier removal of reagents.

One embodiment provides that the punch comprises a cutting edge.

One embodiment provides that the insert is flanged at one end against a section of the container wall.

One embodiment provides that the container comprises a cover, in particular the container comprises a cover which, when closed, presses the flanging against the container wall and thus closes the container, in particular in an airtight and reagent-tight manner.

One embodiment provides that the insert is designed as a hollow cylinder or as a bag.

One embodiment provides that the punch penetrates a wall of the bag when the insert is designed as a bag.

One embodiment provides that the container comprises a magnetic stirrer.

One embodiment provides that the container has a volume of 1 l, 500 ml, or 250 ml.

One embodiment provides that the container is of bottle-like design and is designed as a wide-mouth bottle, in particular with an opening of at least 2.5 cm, in particular of 4 cm.

One embodiment provides that the container wall is chemically resistant, in particular consists of one or more of the substances mentioned below: Polyethylene, high-density polyethylene, polypropylene, polyvinyl chloride, polyethylene terephthalate, polycarbonate, polyamide, polytetrafluoroethylene, or polymethylmethacrylate.

One embodiment provides that the insert consists of one or more of the following substances: Polyethylene, high-density polyethylene, polypropylene, polyvinyl chloride, polyethylene terephthalate, polycarbonate, polyamide, polytetrafluoroethylene, or polymethylmethacrylate.

One embodiment provides that the punch consists of one or more of the following substances: Polyvinyl chloride, polypropylene, polyether ether ketone or a vitroceramic. In general, the punch consists of a reagent-resistant and solvent-resistant substance. The punch is designed to be mechanically strong and stiff in such a way that it can penetrate the closure. Stiffness is achieved by using a rigid material, see above, and/or by appropriate design measures.

The object is further achieved by a method for activating reagents with a container as described above, comprising the following steps: Opening the cover of the container; moving the punch from the first position to the second position; and mixing the reagents which are now no longer separated from one another, in particular by shaking or by means of magnetic stirrers.

One embodiment provides that the method further comprises the following step: Penetrating the predetermined breaking point and inserting a reagent removal tube into the container as far as the container bottom.

In general, one embodiment provides a method with the following steps: Filling separated compartments with, in particular different, reagents; optionally transporting the container to its place of use; eliminating the separation between the compartments; and optionally mixing the reagents or waiting until they mix by themselves. Since the path between the compartments is free after the elimination of the separation between them, the reagents can flow into each other, mix together and dissolve.

One embodiment provides that the container is filled by a method comprising the steps of: Placing the seal onto the punch; inserting the closure plug into the punch; filling a small to medium amount of the second reagent into the punch sitting on the closure plug as a second compartment; inserting the punch into the insert; filling the container as a first compartment with the first reagent; inserting the insert into the container; and screwing a cover onto the container.

### BRIEF DESCRIPTION OF THE DRAWINGS

One embodiment provides that the container is filled by a method comprising the steps of: Placing the seal onto the punch; inserting the closure plug into the punch; filling the container as a first compartment with the first reagent; inserting the insert into the container; filling the insert as a second compartment with the second reagent; inserting the punch into the insert; and screwing a cover onto the container.

This is explained in detail with reference to the following FIGURE.

FIG. 1 shows the claimed container.

### DETAILED DESCRIPTION

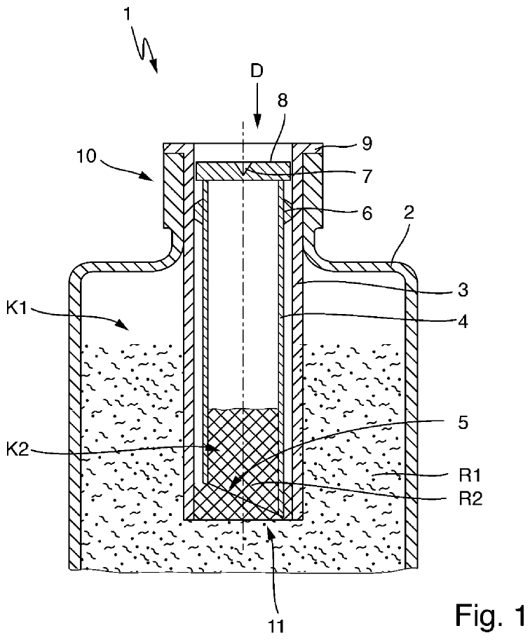

The claimed container in its entirety is denoted by reference sign 1 and is shown in FIG. 1.

The container 1 comprises a container wall 2 which is designed to form a first compartment K1 for a first reagent R1. The container 1 with its wall 2 is of bottle-like design with a bottle neck 10 and a large bottle neck opening, for instance larger than 2.5 cm, in particular larger than 4 cm.

An insert 3 for receiving a second reagent R2 is introduced through the bottle neck 10. The insert 3 is cylindrical, for example. The insert 3 forms a second compartment K2 which is separated from the first compartment K1. In diameter, the insert 3 is smaller than the bottle neck opening. The insert is chemically resistant, in particular resistant to the reagents R1, R2. The insert is closed on one side by a transportable and storage-proof closure 11. The closure 11 is designed, for example, as a membrane. On the opposite side, the insert 3 is lipped (reference numeral 9), such that the lip 9 forms a sealing surface for the bottle neck 10. The insert 3 can transition into a bag underneath the bottle neck 10 for the purpose of volume expansion.

The reagents R1, R2 are already filled into the container 1 at the factory by the distributor of the container. The container 1 is thus immediately ready for operation by the user.

One embodiment provides that only one reagent, for example the second reagent R2, is filled into the container 1 at the factory by the distributor of the container. The corresponding other reagent, in this case the first reagent R1, is filled in directly on site by the user. In this case, the first reagent R1 may be a standard solution, water or a solvent. Water may also be used, for example, to dilute a stock solution or a solid standard substance. As a result, the standard solution is formed from the stock solution exactly filled in by the manufacturer or the standard substance and the amount of water filled in by the user. This procedure saves transport costs.

A hollow cylinder, the punch 4 is introduced into the insert 3. The insert 3 and the punch 4 are sealed in a liquid-tight manner by means of a seal 6. The punch 4 has a cutting edge 5 at the bottom for piercing or pressing out the closure 11. The cutting edge 5 cuts through, penetrates, pierces or presses out the closure 11. Accordingly, the cutting edge 5 can also be designed as a pointed end, knife-like, or the like.

The punch 4 is movable between a first position (top) and a second position (bottom). In moving from the first position to the second position, the punch opens the closure 11. As a result, a path from the second compartment K2 into the first compartment K1 is cleared, whereby second reagent R2 enters the first reagent R1.

After the two reagents R1, R2 are no longer separated from one another, they are mixed. This takes place, for instance, after closing a cover (see below) by shaking the container 1 alternatively or additionally, the container 1 comprises a magnetic stirrer. The entire container can then be placed on a corresponding holder and the reagents R1, R2 are mixed by means of the magnetic stirrer.

On the opposite side, the punch 4 is closed in a fluid-tight manner with a media-resistant closure plug 8. The closure plug 8 has a predetermined breaking point 7, for instance a pre-punched one, through which a reagent removal tube can be pushed after activation and intermixing of all reagents R1, R2 is carried out later. After puncturing, the predetermined breaking point 7 does not give a completely circumferential form fit to the hose, such that, although the hose can be fixed, there is also an air opening to the atmosphere.

The container 1 comprises a cover: When closed, the latter presses the lip 9 of the insert 3 in a sealing manner against the upper edge of the bottle neck 10, whereby the container 1 is tightly closed.

By dividing the interior of the container into at least two separate compartments K1, K2 in which two reagents R1, R2 are stored separately from one another, a simple transport takes place with user-friendly activation of the reagent system by breaking open the barrier and then mixing or dissolving of the reagents R1, R2.

1. A container for reagents for an analyzer in process automation technology, comprising
a container wall which is designed to form a first compartment for a first reagent;
an insert which is arranged at least in some sections in the first compartment, and which forms a second compartment separated from the first compartment for a second reagent,
wherein the insert comprises a closure; and
a punch which is movable at least between a first position and a second position, wherein the punch, in moving from the first position to the second position, opens, cuts through, penetrates, pierces or presses out, the closure and clears a path from the second compartment into the first compartment, whereby second reagent enters the first reagent.

2. The container of claim 1, wherein the punch is arranged in the insert and is mounted movably inside the insert.

3. The container of claim 1, wherein the punch comprises a seal which is arranged on the outer diameter of the punch.

4. The container of claim 1, wherein the punch is designed as a hollow body.

5. The container of claim 1, wherein the punch comprises a closure plug which comprises a predetermined breaking point, wherein a reagent removal tube can be pushed through the predetermined breaking point after the breaking.

6. The container of claim 5, wherein the punch comprises a cutting edge.

7. The container of claim 1, wherein the insert is flanged at one end against a section of the container wall.

9. The container of claim 1, wherein the insert is designed as a hollow cylinder or as a bag.

10. The container of claim 1, wherein the container comprises a magnetic stirrer.

11. A method for activating reagents with a container, the container including a container wall forming a first container for a first reagent; an insert arranged at least in some sections in the first compartment, and which forms a second compartment for a second reagent, wherein the insert comprises a closure; and a punch which is movable at least between a first position and a second position, the method comprising:
opening a cover of the container;
moving the punch from the first position to the second position; and
mixing the reagents which are now no longer separated from one another using magnetic stirrers.

12. The method of claim 11, further comprising:
penetrating the predetermined breaking point and inserting a reagent removal tube into the container as far as the container bottom;
a container wall which is designed to form a first compartment for a first reagent;
an insert which is arranged at least in some sections in the first compartment, and which forms a second compartment separated from the first compartment for a second reagent,
wherein the insert comprises a closure; and
a punch which is movable at least between the first position and the second position, wherein the punch, in moving from the first position to the second position, opens, cuts through, penetrates, pierces or presses out, the closure and clears a path from the second compartment into the first compartment, whereby second reagent enters the first reagent.
